(19) United States
(12) Patent Application Publication
(10) Pub. No.: US 2005/0102170 A1
(43) Pub. Date: May 12, 2005

(54) System for processing transaction data

(76) Inventors: David L. Lefever, Ephrata, PA (US); Robert C. Duff, Atglen, PA (US); Douglas C. Smith, Paoli, PA (US)

Correspondence Address: Alexander J. Burke;Intellectual Property Department, 5th Floor, 170 Wood Avenue South, Iselin, NJ, 08830, US

(21) Appl. No.: 10/936,295

(22) Filed: Sep. 8, 2004

Related U.S. Application Data
(60) Provisional application No. 60/501,336, filed on Sep. 9, 2003.

(51) Int. Cl. G06F 17/60

(52) U.S. Cl. 705/4

(57) ABSTRACT

A system for processing data, representing a financial transaction, includes an input processor, a message generator, and a communication interface. The input processor parses data, representing a first financial transaction, and derives from the data, representing the first financial transaction, data items including a data element and an identifier identifying the first financial transaction. The message generator generates message data, representing a second financial transaction different from the first transaction, and incorporates the data items and an identifier identifying the data element. The communication interface initiates communication of the message data, representing the second financial transaction, to a remote system.

### CROSS-REFERENCE TO RELATED APPLICATIONS

The present application is a non-provisional application of provisional application having Ser. No. 60/501,336 filed by David L. Lefever, et al. on Sep. 8, 2003.

### FIELD OF THE INVENTION

The present invention generally relates to computer information systems. More particularly, the present invention relates to a system for processing transaction data.

### BACKGROUND OF THE INVENTION

Electronic commerce (“e-commerce”) describes the buying, selling, marketing, and servicing of products or services over computer networks. E-commerce includes the electronic transfer of information between businesses through electronic methods, such as electronic data interchange (“EDI”).

EDI is a computer-to-computer exchange of business data according to predefined standards developed and maintained by various organizations such as, for example, American National Standards Institute (“ANSI”) in the United States. EDI translation software provides an interface between an internal computer system of a business and computer systems of other businesses operating according to the predefined standards, to permit the internal computer system of the business to use the business data in non-standard manner while remaining compatible with the computer systems of other businesses.

ANSI Accredited Standards Committee (“ASC”) X12 (i.e., the committed designation) develops EDI standards to facilitate electronic business transactions (i.e. order placement and processing, shipping and receiving, invoicing, payment, cash application data, insurance transactions). ANSI ASC X12 endeavors to structure standards in a manner that EDI translation software can translate data to and from data formats of internal computer systems without extensive reprogramming. This strategy allows companies to maximize their resources required for internally developed or commercial software and private or public-access communication networks. ANSI ASC X12 may be used from any operating system, network, or hardware platform. The ANSI ASC X12 has a hierarchical data structure that is organized by transaction sets, loops, segments, data elements, composite data elements, and sub-elements. Transaction sets are made up of loops, loops are made up of segments, segments are made up of data elements, data elements are made up of composite data elements, and composite data elements are made up of sub-elements. The loops are organized by categories of information. Each data element is variable length with the standard minimum and maximum length.

The Health Insurance Portability and Accountability Act of 1996 Public Law 104-191 (“HIPPA”) was passed by Congress to reform the insurance market and simplify health care administrative processes. HIPAA is partly aimed at reducing administrative costs and burdens in the health care industry by adopting and requiring the use of standardized, electronic transmission of administrative and financial data. HIPAA requires the Department of Health and Human Services (“DHHS”) to adopt national uniform standards for the electronic transmission of certain health information between providers of healthcare products or services.

Providers of healthcare products or services may include entities such as physicians, hospitals, and other medical facilities or suppliers, dentists, and pharmacies, and entities providing medical information to meet regulatory requirements. A payer refers to a third party entity that pays claims or administers the insurance product or benefit or both. For example, a payer may be an insurance company, health maintenance organization (HMO), preferred provider organization (PPO), government agency (Medicare, Medicaid, Civilian Health and Medical Program of the Uniformed Services (CHAMPUS), etc.) or an entity such as a third party administrator (TPA) or third party organization (TPO) that may be contracted by one of those groups. A regulatory agency is an entity responsible, by law or rule, for administering and monitoring a statutory benefits program or a specific healthcare/insurance industry segment.

ANSI ASC X12 837 (e.g., version 4010) is a healthcare claim transaction set that supports the administrative reimbursement processing as it relates to the submission of healthcare claims for both healthcare products and services. The healthcare claim transaction set is used to submit health care claim billing information, encounter information, or both, from providers of health care services to payers, either directly or via intermediary billing companies and claims clearinghouses. It can also be used to transmit health care claims and billing payment information between payers with different payment responsibilities where coordination of benefits is required or between payers and regulatory agencies to monitor the rendering, billing, and/or payment of health care services within a specific health care/insurance industry segment. The healthcare claim transaction set is used for administrative reimbursement for health care products and services for medical, hospital, dental, pharmaceutical, durable medical equipment claims as well as for workers compensation jurisdictional reporting. ANSI ASC X12 837 supports both 837P (Professional Providers), and 837I (Institutional Providers).

In the healthcare claim transaction set, related categories of information are associated by their hierarchy as defined by a hierarchical level (HL) segment. Proper coding of this HL segment allows for information on multiple providers to be reported, as well as information for multiple patients for each provider to be reported. The HL segment defines a parent-child relationship. Related data elements are organized in segments.

ANSI ASC X12 835 (e.g., version 4010) is a remittance advice transaction set that permits remittance advice information to be received electronically in a standard format. EDI translation software may receive the remittance advice transaction set to post payment information to an internal computer system of a business, without manual intervention.

Sometimes healthcare claims are sent using ANSI ASC X12 837 to more than one healthcare payer, such as a primary payer and a secondary payer, which may include a private healthcare insurance company, Medicare, and/or a patient. Typically, healthcare claims are first sent to the primary payer for reimbursement. If the reimbursement from the primary payer covers the entire healthcare claim, then the healthcare claim is typically settled. However, if the reimbursement from the primary payer does not cover the entire healthcare claim, then the healthcare claim is sent to the secondary payer for reimbursement of the unpaid part of the healthcare claim. The healthcare claim sent to the secondary payer includes remittance information received from the prior payer so that the secondary payer can determine what claims the primary payer has reimbursed. Healthcare providers keep track of remittances received from multiple payers by creating a repository for storing and updating received remittance information. However, existing systems lack capability to efficiently create, monitor, and track secondary claims for communication to secondary payers using electronic data exchange, for example. Accordingly, there is a need for a system for processing transaction data that overcomes these and other disadvantages of the prior systems.

### SUMMARY OF THE INVENTION

A system for processing data, representing a financial transaction, includes an input processor, a message generator, and a communication interface. The input processor parses data, representing a first financial transaction, and derives from the data, representing the first financial transaction, data items including a data element and an identifier identifying the first financial transaction. The message generator generates message data, representing a second financial transaction different from the first transaction, and incorporates the data items and an identifier identifying the data element. The communication interface initiates communication of the message data, representing the second financial transaction, to a remote system.

### BRIEF DESCRIPTION OF THE DRAWINGS

FIG. 1 illustrates a system for processing transaction data, in accordance with a preferred embodiment of the present invention.

FIG. 2 illustrates a method for processing transaction data for use with the system, as shown in FIG. 1, in accordance with a preferred embodiment of the present invention.

FIG. 3 illustrates an ANSI ASC X12 835 compatible transaction, in accordance with a preferred embodiment of the present invention.

FIG. 4 illustrates a user interface for claim key adapted to create the ANSI ASC X12 835 compatible transaction, as shown in FIG. 3, in accordance with a preferred embodiment of the present invention.

FIG. 5 illustrates a user interface for claim adjustment information adapted to create the ANSI ASC X12 835 compatible transaction, as shown in FIG. 3, in accordance with a preferred embodiment of the present invention.

FIG. 6 illustrates a user interface for Medicare inpatient (IP) adjudication adapted to create the ANSI ASC X12 835 compatible transaction, as shown in FIG. 3, in accordance with a preferred embodiment of the present invention.

FIG. 7 illustrates a user interface for Medicare outpatient (OP) adjudication adapted to create the ANSI ASC X12 835 compatible transaction, as shown in FIG. 3, in accordance with a preferred embodiment of the present invention.

FIG. 8 illustrates a user interface for service payment information adapted to create the ANSI ASC X12 835 compatible transaction, as shown in FIG. 3, in accordance with a preferred embodiment of the present invention.

FIG. 9 illustrates a user interface for service adjustment adapted to create the ANSI ASC X12 835 compatible transaction, as shown in FIG. 3, in accordance with a preferred embodiment of the present invention.

### DETAILED DESCRIPTION OF THE PREFERRED EMBODIMENTS

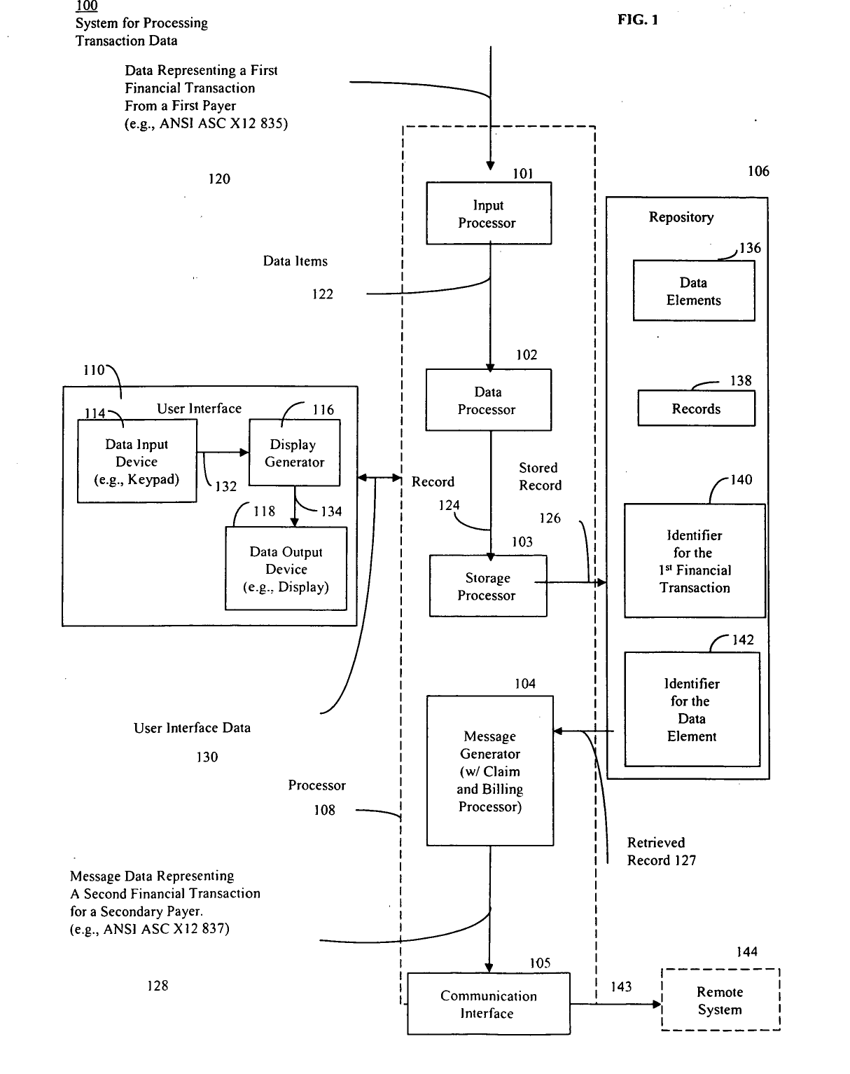

FIG. 1 illustrates a system (“system”) 100 for processing transaction data. The system 100 includes an input processor 101, a data processor 102, a storage processor 103, a message generator 104, a communication interface 105, a repository 106, and a user interface 110. The repository 106 further includes data element 136, records 138, an identifier for the first financial transaction 140, and an identifier for the data element 142. The user interface 110 further includes a data input device 114, a display generator 116, and a data output device 118. The system 100 communicates with a remote system 144, which is shown in dashed lines because the remote system 144 is not part of the system 100.

The system 100 may by used by any type of enterprise, and is intended for use by a providers of healthcare products or services responsible for servicing the health and/or welfare of people in its care. A healthcare provider may provide services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, a user, and an individual.

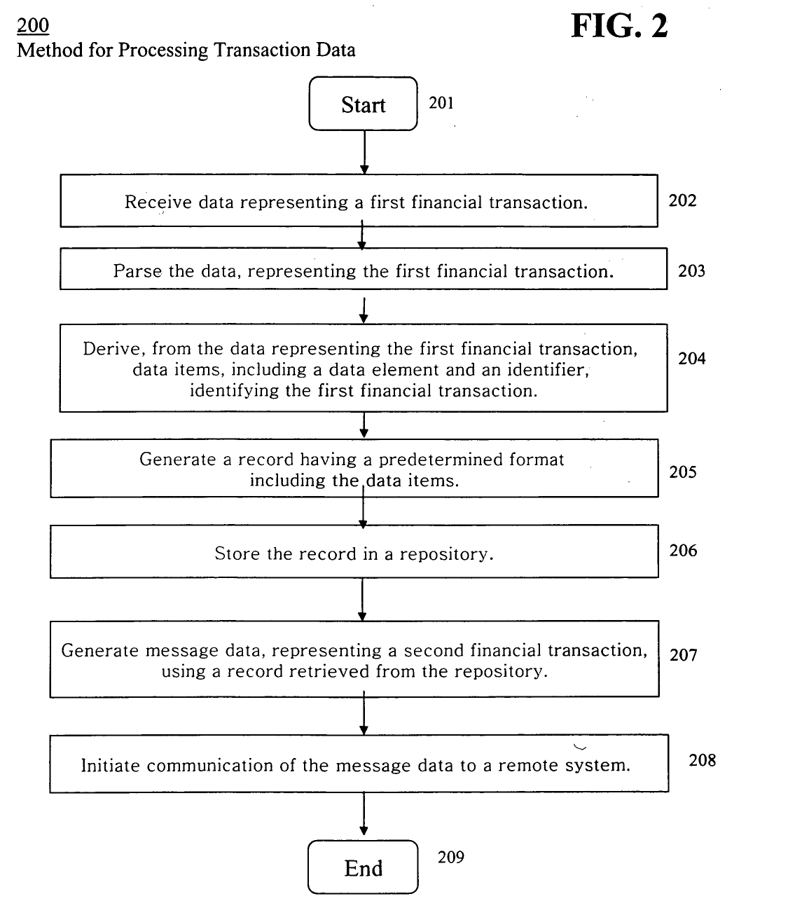

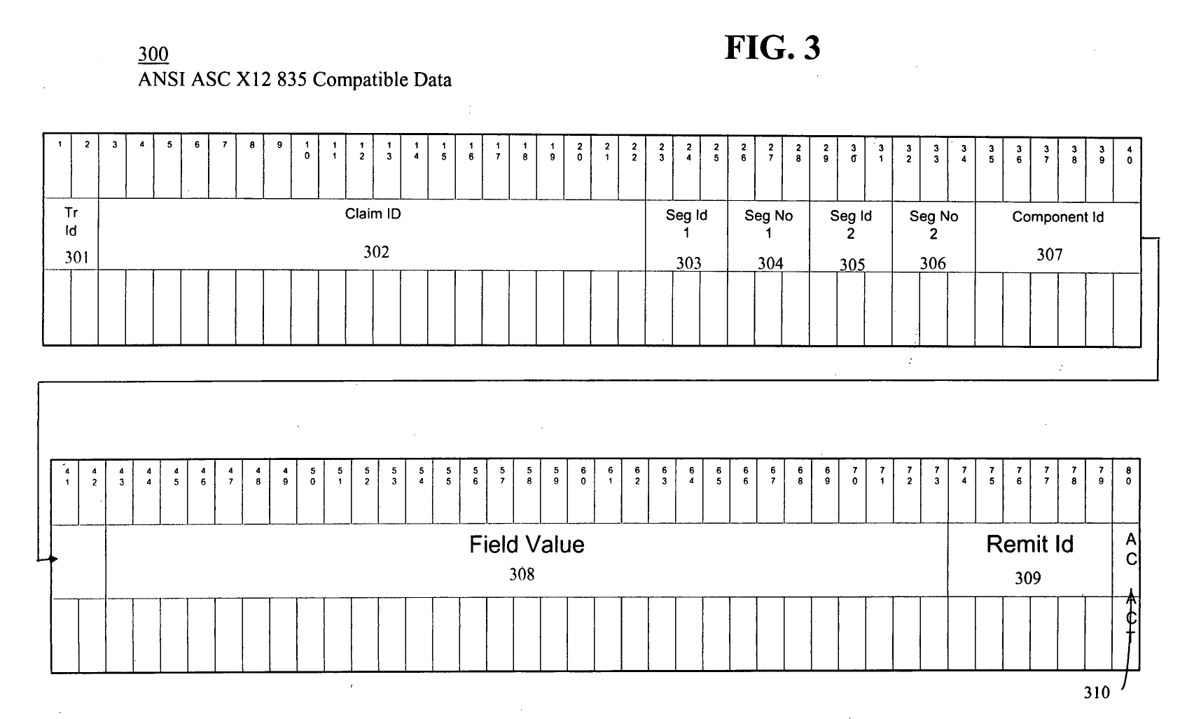

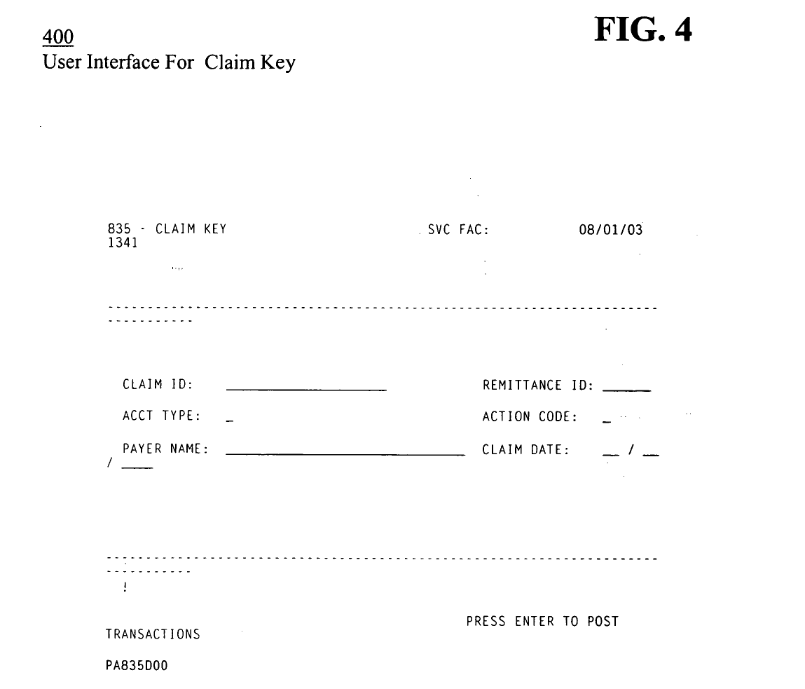

Generally, the system 100, as shown in FIG. 1, and a method 200, as shown in FIG. 2, receives data, representing a first financial transaction, (e.g., an ANSI ASC X12 835 compliant transaction set) 120 related to reimbursement payment from a first payer. The system 100 generates ANSI ASC X12 835 compatible data (“compatible data”) 300, as shown in FIG. 3, in response to receiving data manually entered by a user via display images, as shown in FIGS. 4-9. Alternatively, the system 100 may generate the compatible data 300 in response to receiving data automatically from a file having the ANSI ASC X12 835 transaction set. The system 100 stores appropriate compatible data 124, which is necessary for billing a secondary payer, in the repository 106. The stored compatible data is a subset of the received an ANSI ASC X12 835 transaction set. When the system 100 receives a new ANSI ASC X12 835 transaction set, the system 100 also identifies and maintains (i.e., updates; e.g., add, delete, replace, change, etc.) individual fields in the compatible data stored in the repository 106. The system 100 retrieves the compatible data stored in the repository 106 from the repository 106 to generate message data, representing a second financial transaction, (e.g., an ANSI ASC X12 837 compliant transaction set) 128, different from the first financial transaction, related to a healthcare claim for a secondary payer.

In summary, the system 100 generates, stores, and maintains ANSI ASC X12 835 compatible data 124 in response to receiving data representing ANSI ASC X12 835 compliant transaction set 120, and generates data representing ANSI ASC X12 837 compliant transaction set in response to using retrieved ANSI ASC X12 835 compatible data 124. The term “compliant,” as used herein, means that the transaction set meets the ANSI ASC X12 standard for that particular transaction set (i.e. 835 or 837). The term “compatible,” as used herein, means that the data is interoperable with the ANSI ASC X12 standard for a particular transaction set (i.e. 835 or 837). Therefore, the system 100 provides a type of EDI translation function, as described herein, for generating, storing, maintaining, and using the ANSI ASC X12 835 compatible data 124. The EDI translation function may be a custom software application (licensed or unlicensed). Aspects of the EDI translation function in the system 100 may be advantageously incorporated into a modified ANSI ASC X12 standard.

The input processor 101 represents any type of communication interface that receives any type of signal, such as the data, representing the first financial transaction, 120 (e.g., an ANSI ASC X12 835 transaction set) from the first payer. The ANSI ASC X12 835 compliant transaction set 120 received from the first payer is a delimited, variable length, transaction record containing reimbursement information for a healthcare claim. The ANSI ASC X12 837 compliant transaction set 128 includes specific segments of data that are received from previous payers in the ANSI ASC X12 835 compliant transaction set 120. Data received in the ANSI ASC X12 835 compliant transaction set 120 includes: claim level Claim Adjustment Segments (CAS) segments, a claim level date segment (DTM), a claim level Medicare Inpatient Adjudication (MIA) segment for inpatient accounts, a claim level Medicare Outpatient Adjudication (MOA) segment for outpatient accounts, service line (SVD) segments, Service line Claim Adjustment (CAS) segments, and service line DTM segments. In an ANSI ASC X12 835 compliant transaction set 120, there can be up to ninety nine claim level CAS segments, one claim level MOA, one claim level MIA, nine hundred ninety nine service line SVD segments (one for each summarized line on the original claim), one service level DTM segment per SVD segment, and ninety nine service line CAS segments per SVD segment. In order to simplify the storage of this volume of data 120, the system 100 employs the ANSI ASC X12 835 compatible transaction set 300 (FIG. 3) to identify the segment in the ANSI ASC X12 835 compliant transaction set 120, having the appropriate data, so that the system 100 can quickly and efficiently update the repository 106.

A user manually enters remittance information into the system 100 via display images, for example, as shown in FIGS. 4-9, using the user interface 110. In this case, the user typically reads the remittance information from an Explanation Of Benefits (EOB) received from the payer. The data entered by the user generates multiple ANSI ASC X12 835 compatible transaction sets 300; i.e., one ANSI ASC X12 835 compatible transaction set 300 for each piece of data entered by the user). The user interface 100 electronically generates the data 120, representing an ANSI ASC X12 835 compliant transaction set, in response to receiving the manually entered data. Alternatively, the data 120 may be received automatically from an electronic file including the ANSI ASC X12 835 compliant transaction set. In the alternative case, system 100 receives the data 120 via a communication network from a remote computer system (not shown), which is different from the remote computer system 144.

The input processor 101 also parses the received data 120 to identify a data element needed to update the data element 136 stored in the repository 106. The term “parsing” may otherwise be called dissecting, separating, distinguishing, identifying, categorizing, sorting, etc.

The input processor 101 also derives data items 122 from the data element. The term “derives” may otherwise be called determines, identifies, finds, calculates, etc.

The data processor 108 generates a record having a predetermined format including the data items 122 (e.g., location and value) that are necessary for the system 100 to perform the secondary billing function.

The storage processor 103 stores and maintains (e.g., using an update function) the appropriate record 124 in the repository 106.

The message generator 104 generates message data, representing the second financial transaction, 128 (e.g. an ANSI ASC X12 837 compliant transaction set) using a record 127 retrieved from the repository 106. The message generator 104 also includes the claims processor and the billing processor, each of which determines when a secondary claim and bill, respectively, needs to be generated for a secondary healthcare claim. The retrieved record 127 (otherwise called a Remittance Retention File (RRF)) is a segmented, Virtual Storage Access Method (VSAM) file, for example, that contains data that is necessary to generate the ANSI ASC X12 837 compliant transaction set 128.

VSAM is a file management system used on IBM mainframes. VSAM speeds up access to data in files by using an inverted index (otherwise called a B+tree) of records added to each file. The index is a list of keys (otherwise called key field, sort key, index, or key word), each of which identifies a unique record. A key is a field that the system 100 uses to sort data. For example, if the system 100 sorts records by age, then the age field is a key. Most database management systems (DBMSs) permit more than one key so that the system 100 can sort records in different ways. One of the keys is designated the primary key, and holds a unique value for each record. A key field that identifies records in a different table is called a foreign key. Indices make it faster to find specific records and to sort records by the index field (i.e., the field used to identify each record). Records are composed of fields, each of which contains one item of information. A set of records constitutes a file. For example, a personnel file might contain records that have three fields: a name field, an address field, and a phone number field. Many legacy software systems (e.g., DBMSs running on mainframes or minicomputers) use VSAM to implement database systems.

Two sources provide the stored ANSI ASC X12 835 compatible data to populate the ANSI ASC X12 837 compliant transaction set 128. A first source is an existing file that was sent to a patient accounting executable application. A second source is a data entry pathway (e.g., 3270) created to permit a user to manually enter the ANSI ASC X12 835 compatible data. The system 100 sends the ANSI ASC X12 835 compatible data to the repository 106, and to patient accounting executable application to be processed at the end of the day.

When the system 100 generates the ANSI ASC X12 837 compliant transaction set 128 for a second payer, the system 100 also adds the appropriate ANSI ASC X12 835 compatible data to the ANSI ASC X12 837 compliant transaction set 128 for the first payer through a current billing flow. A mapper application maps the appropriate ANSI ASC X12 835 compatible remittance data to the ANSI ASC X12 837 compliant transaction set 128 for a second payer. The system 100 employs three options for matching service line level remit information, described as follows.

1. The mapper application makes a best attempt at matching the detail. First, the mapper application attempts to find exact matches on service date, revenue code, and Healthcare Common Procedure Code (HCPC) code, and assigns that remit information. Second, the mapper application attempts to match line items that are closely related, based on the same three criteria. Details with no matching claim line information are placed in the first available 837 service line. Throughout the matching process, accommodation charges are kept separate from ancillary charges.

2. The mapper application puts remit information in the first 837 service line. The mapper application associates remittance information with the first 837 service line until segments are filled, then the mapper application processes the second service line, and then the operation continues until the mapper application assigns the remittance data.

3. When the mapper application does not match a service line, the claim level information is included on the secondary claim. The system 100 sends the claim IDs of previous claims and the hospital region code to the mapper application through records of a formatted file (e.g., EV6).

The communication interface 105 initiates communication of the message data 128 to the remote system 144 via the communication path 143. The message data 128 may be communicated to one or more of the following: (a) a display on a reproduction device (e.g., the data output device 118), (b) communication to the remote system 144, and (c) print output (e.g., the data output device 118). The message data 128 may be the same or different than the user interface data 130 communicated to the user interface 110.

The repository 106 represents a data storage element and may otherwise be called a memory device, a storage device, a database, etc. The database may be of any type including for example, a Microsoft® (MS) Access ® database, or a sequel (SQL) database. The repository 106 stores the data element 136, the records 138, the identifier for the first financial transaction 140, and the identifier for the data element 142.

The user interface 110 permits a user to interact with the system 100 by inputting data into the system 100 and/or receiving data from the system 100. The user interface 110 generates one or more display images, as shown in FIGS. 4-9, for example.

The data input device 114 provides input data 132 to the display generator 116 in response to receiving input information either manually from a user or automatically from an electronic device. The data input device 114 is a keyboard, but also may be a touch screen, or a microphone with a voice recognition application, for example.

The display generator 116 generates display signals 134, representing one or more images for display, in response to receiving the input data 132 or other data from the system 100, such as the user interface data 130 from the processor 108.

The display generator 116 is a known element including electronic circuitry or software or a combination of both for generating display images or portions thereof. The image for display may include any information stored in the repository 106 and any information shown in FIGS. 4-9. An action by a user, such as, for example, an activation of a displayed button, may cause the image to be displayed.

The data output device 118 represents any type of element that generates data. The data output device 118 is a display that generates display images, as shown in FIGS. 4-9, in response to receiving the display signals 134, but also may be a speaker or a printer, for example.

The user interface 10 provides a graphical user interface (GUI), as shown in FIGS. 4-9, for example, wherein portions of the data input device 114 and portions of the data output device 118 are integrated together to provide a user-friendly interface. The GUI may have any type of format, layout, user interaction, etc., as desired, and should not be limited to that shown in FIGS. 4-9. The GUI may also be formed as a web browser (not shown).

In the system 100, one or more elements may be implemented in hardware, software, or a combination of both. Further, one or more elements may include one or more processors, collectively represented as processor 108, such as the input processor 101, the data processor 102, the storage processor 103, the message generator 104, the communication interface 105, as well as the display generator 116. A processor includes any combination of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or microprocessor.

A processor performs tasks in response to processing an object. An object comprises a grouping of data and/or executable instructions, an executable procedure, or an executable application. An executable application comprises code or machine readable instruction for implementing predetermined functions including those of an operating system, healthcare information system, or other information processing system, for example, in response user command or input.

The system 100 may be fixed or mobile (i.e., portable), and may be implemented in a variety of forms including a personal computer (PC), a desktop computer, a laptop computer, a workstation, a network-based device, a personal digital assistant (PDA), a smart card, a cellular telephone, a pager, and a wristwatch. The system 100 may be implemented in a centralized or decentralized configuration.

The system 100 provides an electronic mechanism for a healthcare provider to generate an ANSI ASC X12 837 compliant transaction set 128, representing a healthcare claim to a secondary payer, in response to receiving an ANSI ASC X12 835 compliant transaction set 120, representing a remittance advice from a first payer, using the compatible data 126 retrieved from the repository. The compliant or compatible healthcare information may be represented in any file format including numeric files, text files, graphic files, video files, audio files, and visual files. The graphic files include a graphical trace including, for example, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The system 100 communicates with the remote computer system 144 over a wired or wireless communication path 143, otherwise called a network, a link, a channel, or a connection. The communication path 143 may use any type of protocol or data format including an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, a Digital and Imaging Communications (DICOM) protocol, and a Health Level Seven (HL7) protocol.

FIG. 2 illustrates a method 200 for processing transaction data for use with any system, such as the system 100, as shown in FIG. 1. The system 100 may perform other steps in addition to or as a substitute for the steps described in FIG. 2, as described herein.

At step 201, the method 200 starts.

At step 202, the input processor 102 receives the data, representing a first financial transaction, 120 related to remittance advice received from the primary payer.

At step 203, the input processor 104 parses the data, representing the first financial transaction, 120.

At step 204, the input processor 104 derives, from the data representing the first financial transaction, data items 122, including a data element 136 and an identifier 140, identifying the first financial transaction.

At step 205, the data processor 108 generates a record 124 having a predetermined format including at least some of the data items 122.

At step 206, the storage processor 103 stores the record 126 in the repository 106.

At step 207, the message generator 104 generates message data, representing the second financial transaction, 128 using a record 127 retrieved from the repository 106.

At step 208, the communication interface 105 initiates communication of the message data 128 to the remote system 144 via the communication path 143.

At step 209, the method 200 ends.

FIG. 3 illustrates ANSI ASC X12 835 compatible data 300 adapted to be received by the system 100, as shown in FIG. 1, and the method 200, as shown in FIG. 2. The ANSI ASC X12 835 compatible data 300 is eighty characters long and is used to identify any piece of an ANSI ASC X12 835 compliant transaction set 120 remittance data to be added or maintained in the repository 106. An ANSI ASC X12 837 compliant transaction 128 for a secondary claim potentially may require data from an ANSI ASC X12 835 compliant transaction 120 remittance data. The ANSI ASC X12 835 compatible data 300 includes the following fields.

1. Characters 1-2: Transaction (Tr) Identifier (ID) 301.

2. Characters 3-22: Claim ID 302 is a unique claim identifier that is sent on the ANSI ASC X12 837 compliant transaction set 128 corresponding to the healthcare claim and is returned on the ANSI ASC X12 835 compliant transaction set 120 corresponding to the remittance. The Claim ID 302 links the remittance to the original healthcare claim.

3. Characters 23-25: Seg ID 1 303 is a segment identifier of the segment which the data is coming from on the ANSI ASC X12 835 compliant transaction set 120. Examples of the Seg ID 1 303 include the following: CAS—Claim Level Adjustment segment; MIA—Medicare Inpatient Adjudication Segment; MOA—Medicare Outpatient Adjudication Segment; and SVC—Service Line Payment Segment.

4. Characters 26-28: Seg No 1 304 identifies the occurrence of the segment the data is returned on.

5. Characters 29-31: Seg Id 2 305 is the segment identifier of a subordinate segment, if necessary. For example, there are CAS segments that are subordinate to the SVC segment. So to value data from that segment, Seg Id 1 303 would be SVC, and Seg Id 2 305 would be CAS.

6. Characters 32-34: Seg No 2 306 identifies the occurrence of the subordinate segment.

7. Characters 35-42: Component Id 307 is an eight-character name to identify the field that is being valued.

8. Characters 43-73: Field Value 308 is the actual value returned.

9. Characters 74-79: Remit Id 309 is an identifier that is user entered to distinguish remittance data if multiple remits are returned for the same claim.

10. Character 80 (item 310): Provides for an action code to allow adding, changing, or deleting of the data.

The system 100 provides the following features and advantages:

1. Storing ANSI ASC X12 835 compatible data 300, rather than an entire ANSI ASC X12 835 compliant transaction set 120, by excluding non-essential data to provide an efficient, usable, and easily accessible format (e.g., a segmented file or a database).

2. Significantly decreasing the storage requirements of the repository 106, and increasing the performance of the system 100 when performing the secondary billing function. By not storing the entire ANSI ASC X12 835 compliant transaction set 120, the system 100 advantageously simplifies the maintenance of the data stored in the repository 106 by permitting the system 100 to identify and maintain a specific field of the compatible data stored in the repository 106. Also, by not storing the entire ANSI ASC X12 835 compliant transaction set 120, the system 100 does not have to parse the entire ANSI ASC X12 835 compliant transaction set 120 every time the system 100 accesses the repository 106 to identify or retrieve data when performing the secondary billing function.

3. Employs the same single transaction format in ANSI ASC X12 835 compatible data 300 to enter any piece of the different data items of ANSI ASC X12 835 compliant transaction set 120 that need to be stored in the repository 106. The single transaction format simplifies data entry or formatting of records from the ANSI ASC X12 835 compatible data 300.

4. The ANSI ASC X12 835 compatible data 300 stores the information necessary to completely identify where the data needs to be stored in the repository 106. The ANSI ASC X12 835 compatible data 300 identifies the exact segment and offset within that segment where the data is to be in the repository 106. This advantageously enables a generic update or retrieval function to be able to access the needed piece of data easily.

5. Identifying a particular piece of the ANSI ASC X12 835 compliant data 120 being updated (i.e., add, change, or delete), and updating the appropriate record 136 in the repository 106. This permits a generic update/access function to process the ANSI ASC X12 835 compliant data 120, which makes the update/access functions generic and simpler. The system 100 uses segment identifiers 303 and 305 and segment numbers 304 and 306 to specify the exact data to be processed. The system 100 also uses a component identifier 307 to further identify the data. For example, the following transaction would update the claim 000000000000 which has a remit identifier of 000006.

7X00000000000000000000SVC003CAS001FIELDID1VALUE 000006C

The field “FIELDID1” in the first CAS segment under the third service line segment would be changed to a value of “VALUE.”

6. Permitting multiple remittances to be stored for a given healthcare claim.

7. Permitting a unique claim ID, which maps the remittance information to the healthcare claim.

8. Rebilling an item on a healthcare claim that does not have a corresponding received remittance.

9. Providing a unique claim ID field 302 in the ANSI ASC X12 835 compatible data 300 to link the ANSI ASC X12 835 compliant transaction set 120 for the remittance information with the ANSI ASC X12 837 compliant transaction set 128 for a specific claim, and providing a remit identifier 309, which can be valued by the user to identify a particular remittance when multiple remits are returned for the same healthcare claim. For instance, an ANSI ASC X12 837 compliant transaction 128 for a claim is sent to the primary payer with a claim ID 302 of 11111111111100X01001. The payer pays certain lines on the claim, but appends others for additional data. The system 100 is able to receive that remit data in the repository 106, and with a remit ID 309 of U00001. When the pending charges are paid, another remittance can be added to the repository 106 with a remit ID 309 of U00002. This process allows two remittances to be associated with the same claim for secondary billing purposes.

10. The system splits out and processes the ANSI ASC X12 835 compatible data 300 for transaction day-end processing. The process includes the maintenance function that performs the transaction editing, and updates the repository 106 with the new data. The first part of the day-end flow creates a file that includes the transactions and specifies which transactions posted and which transactions had errors. The second part of the day-end flow involves two reporting modules. The first reporting module reads in the file from the maintenance program, and outputs a report of transactions in error and the error codes. The second reporting module provides a report that lists posted transactions.

FIGS. 4-9 each provide examples of display images generated by the user interface 110 permitting a user to manually enter various data, representing an ANSI ASC X12 835 compliant transaction, 120 into the system 100. The display images presented in FIGS. 4-9 are for example only and do not include the entire set of data, representing an ANSI ASC X12 835 compliant transaction, 120 that may be presented to the user. Each display image in FIGS. 4-9 include header information describing a particular type of information representing ANSI ASC X12 835 compliant transaction 120. Each display image in FIGS. 4-9 also includes footer information describing user command instructions, and a display image identification. Each display image in FIGS. 4-9 includes blank lines next to a right side the terms or phrases displayed permitting the user to manually enter the appropriate data read from a received ANSI ASC X12 835 compliant transaction 120. After the user finishes entering the appropriate data in to a display image, the user presses an “enter” key on the keyboard to post the transaction(s) to the system 100. The system 100 receives and processes the posted transaction in the form of the ANSI ASC X12 835 compatible transaction 300, as described herein.

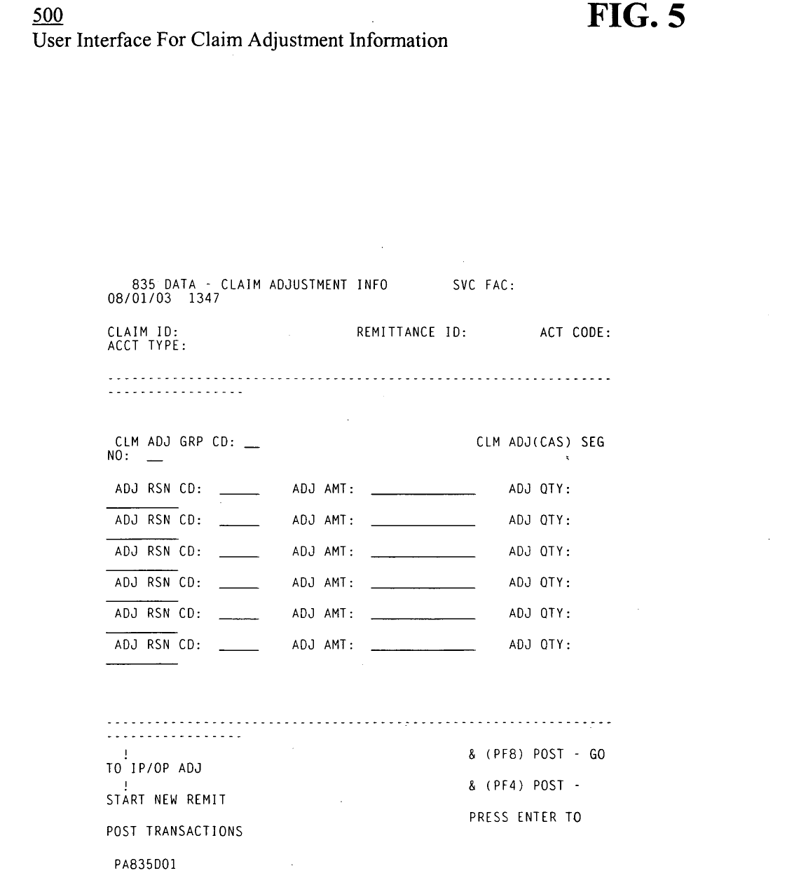

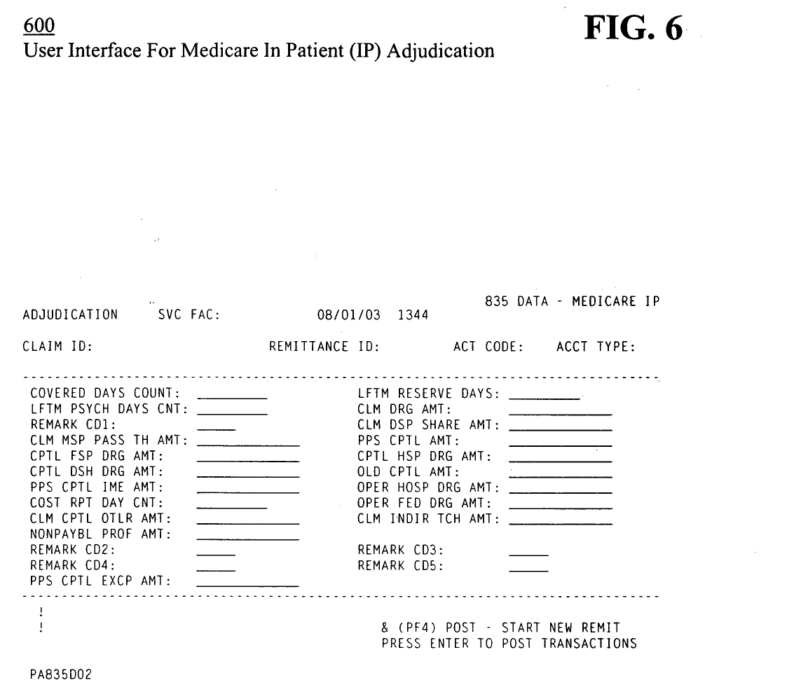

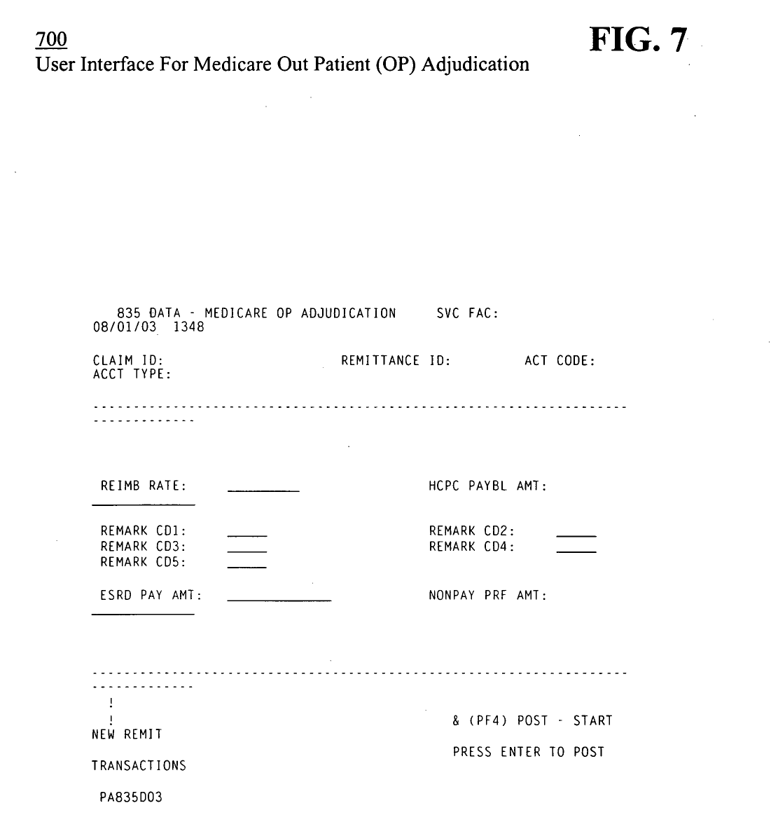

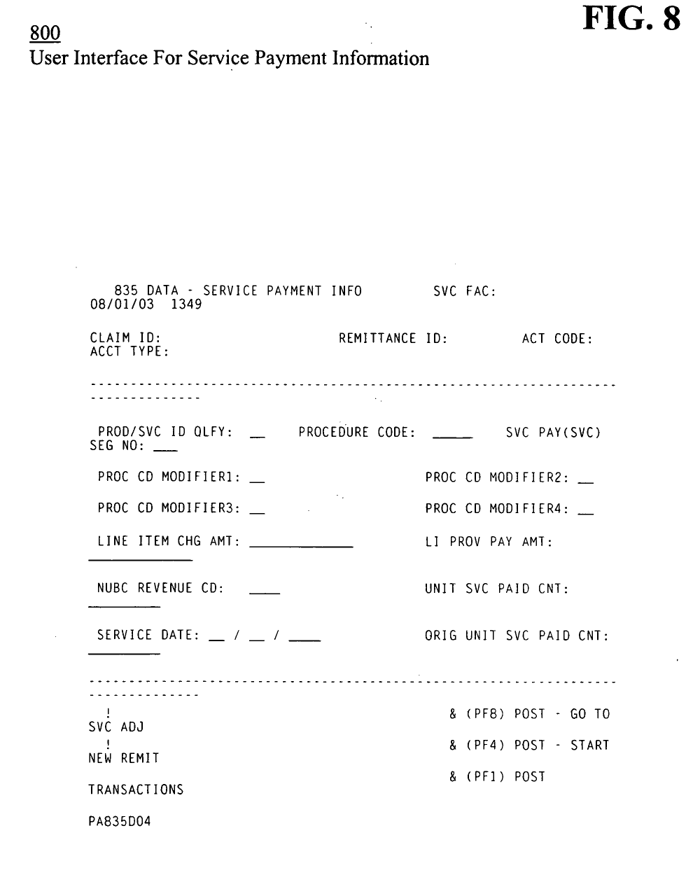

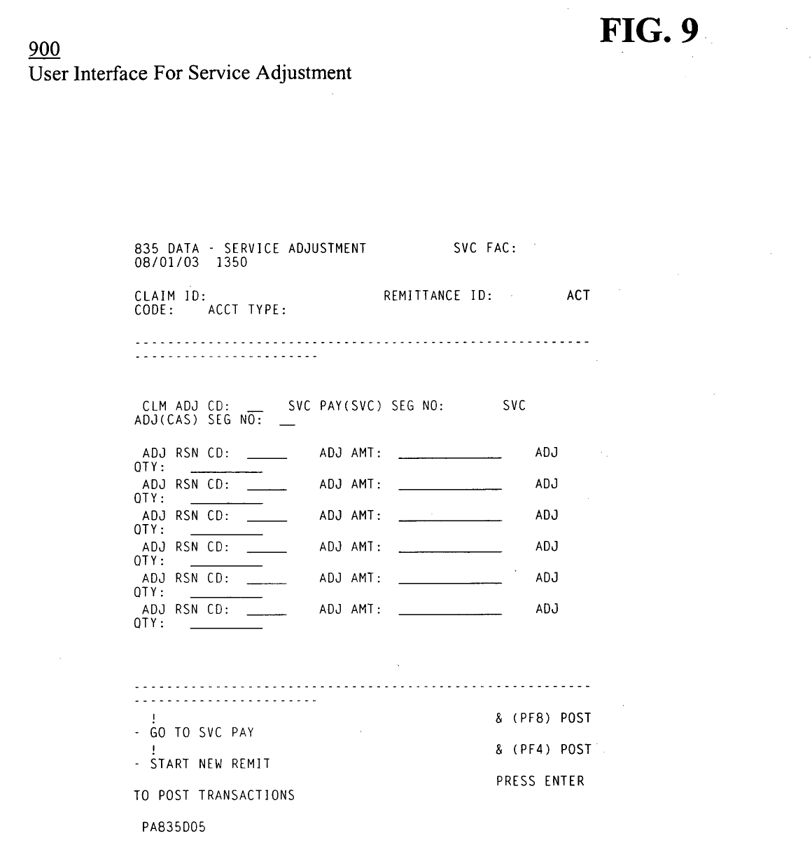

FIG. 4 illustrates a user interface for claim key 400 adapted to create the ANSI ASC X12 835 compatible transaction, as shown in FIG. 3. FIG. 5 illustrates a user interface for claim adjustment information 500 adapted to create the ANSI ASC X12 835 compatible transaction, as shown in FIG. 3. FIG. 6 illustrates a user interface for Medicare inpatient (IP) adjudication 600 adapted to create the ANSI ASC X12 835 compatible transaction, as shown in FIG. 3. FIG. 7 illustrates a user interface for Medicare outpatient (OP) adjudication 700 adapted to create the ANSI ASC X12 835 compatible transaction, as shown in FIG. 3. FIG. 8 illustrates a user interface for service payment information 800 adapted to create the ANSI ASC X12 835 compatible transaction, as shown in FIG. 3. FIG. 9 illustrates a user interface for service adjustment 900 adapted to create the ANSI ASC X12 835 compatible transaction, as shown in FIG. 3.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A system for processing data representing a financial transaction, comprising:
an input processor for parsing data, representing a first financial transaction, and for deriving, from said data, representing said first financial transaction, data items including a data element and an identifier, identifying said first financial transaction;
a message generator for generating message data, representing a second financial transaction, different from said first transaction, and incorporating said data items and an identifier identifying said data element; and
a communication interface for initiating communication of said message data, representing said second financial transaction, to a remote system.

2. A system according to claim 1, wherein
said first financial transaction comprises a remittance associated with a first claim for financial reimbursement for services provided by a healthcare provider organization to a particular patient, and
said second financial transaction comprises a second claim for an item of said first claim, including said data element.

3. A system according to claim 1, wherein
said data, representing said first financial transaction, comprises ANSI ASC X12 835 compliant transaction data.

4. A system according to claim 1, wherein
said data, representing said second financial transaction, comprises ANSI ASC X12 837 compliant transaction data.

5. A system according to claim 1, wherein
said message generator generates message data, representing said second financial transaction, using information derived from said data representing said first financial transaction to position said data element in said data, representing said second financial transaction.

6. A system according to claim 5, wherein
said message generator uses said information derived from said data, representing said first financial transaction, to map a position of said data element in said data, representing said first financial transaction, to a position in said data, representing said second financial transaction.

7. A system according to claim 1, including
said message generator generates said message data, representing said second financial transaction, using stored information including at least one of: (a) a location identifier identifying location of said data element within said data, representing said first financial transaction, (b) a code identifying whether said data element is to be added to or deleted from said data, representing said second financial transaction, and (c) a code identifying whether said data element is to replace a corresponding data element in said data, representing said second financial transaction.

8. A system according to claim 1, wherein
said first financial transaction comprises at least one of: (a) a claim for financial reimbursement for services provided by a service provider organization, (b) a bill for financial reimbursement for services provided by a service provider organization, (c) a remittance associated with a claim for financial reimbursement for services provided by a service provider organization, and (d) a remittance as payment for services provided by a service provider organization.

9. A system according to claim 1, wherein
said message generator generates said message data, representing said second financial transaction, using a record of predetermined format incorporating said data element in a first data field together with other data fields incorporating data items associated with said data element including,
(a) an identifier identifying said first financial transaction, and
(b) an identifier identifying said data element.

10. A system for processing data representing a financial transaction, comprising:
an input processor for receiving a data element derived from data, representing a financial transaction;
a data processor for generating a record of predetermined format incorporating said data element in a first data field together with other data fields incorporating data items associated with said data element including,
(a) an identifier identifying said financial transaction, and
(b) an identifier identifying said data element; and
a storage processor for initiating storage of said generated record in a repository in response to user command.

11. A system according to claim 10, wherein
said financial transaction comprises a remittance associated with a claim for financial reimbursement for services provided by a healthcare provider organization to a particular patient.

12. A system according to claim 10, wherein
said financial transaction comprises a remittance associated with a claim for financial reimbursement for services provided by a healthcare provider organization to a particular patient, and including
a claim processor for determining from said record whether a remittance has been received for a particular item of said claim, and for initiating generation of a second claim, incorporating said data element, for said particular item in response to a determination no remittance has been received for said particular item.

13. A system according to claim 10, wherein
said data representing a financial transaction comprises ANSI ASC X12 835 compliant transaction data.

14. A system according to claim 10, including
a message generator for using said data items in generating message data incorporating said data element.

15. A system according to claim 14, wherein
said message generator generates said message data incorporating said data element by using data in data fields in said generated record to position said data element in said generated message data.

16. A system according to claim 15, wherein
said generated message comprises ANSI ASC X12 837 compliant transaction data.

17. A system according to claim 10, wherein
said data, representing a financial transaction, comprises ANSI ASC X12 835 compliant transaction data and including
a message generator for generating a message comprising ANSI ASC X12 837 compliant transaction data incorporating said data element by using data in data fields in said generated record to map a position of said data element in said data, representing said ANSI ASC X12 835 compliant transaction data, to a position in said ANSI ASC X12 837 compliant generated message.

18. A system according to claim 10, wherein
said generated record includes at least one of: (a) a location identifier identifying location of said data element within said data, representing a financial transaction, (b) a code identifying whether said data element is to be added to or deleted from a different second record, and (c) a code identifying whether said data element is to replace a corresponding data element in a different second record.

19. A system according to claim 10, wherein
said financial transaction comprises at least one of: (a) a claim for financial reimbursement for services provided by a service provider organization, (b) a bill for financial reimbursement for services provided by a service provider organization, (c) a remittance associated with a claim for financial reimbursement for services provided by a service provider organization, and (d) a remittance as payment for services provided by a service provider organization.

20. A system according to claim 10, wherein
said input processor parses said data, representing said financial transaction, and derives said data element from said data, representing said financial transaction.

21. A system according to claim 10, wherein
said financial transaction comprises a remittance associated with a claim for financial reimbursement for services provided by a healthcare provider organization to a particular patient and including
a billing processor for determining from said record whether a remittance has been received for a particular item of said claim, and for initiating generation of a second claim for said particular item in response to a determination no remittance has been received.

22. A system for processing data representing a financial transaction, comprising:
a repository including at least one record incorporating a data element derived from data representing a first financial transaction, an identifier identifying said first financial transaction, and an identifier identifying said data element;
a message generator for generating message data, representing a second financial transaction, using a record derived from said repository to position said data element in said message data; and
a communication interface for initiating communication of said message data, representing said second financial transaction, to a remote system.

23. A method for processing data representing a financial transaction, comprising the activities of:
parsing data representing a first financial transaction;
deriving, from said parsed data, representing said first financial transaction, data items including, said data element, and an identifier identifying said first financial transaction;
generating message data, representing a second financial transaction, different from said first transaction;
incorporating said data items and an identifier identifying said data element in said generated message data, representing said second financial transaction; and
initiating communication of said message data, representing said second financial transaction, to a remote system.

24. A method for processing data representing a financial transaction, comprising the activities of:
receiving a data element derived from data representing a financial transaction;
generating a record of predetermined format incorporating said data element in a first data field together with other data fields incorporating data items associated with said data element including,
(a) an identifier identifying said financial transaction; and
(b) an identifier identifying said data element; and
initiating storage of said generated record in a repository in response to user command.

25. A method for processing data representing a financial transaction, comprising the activities of:
storing at least one record incorporating a data element derived from data representing a first financial transaction, an identifier identifying said first financial transaction and an identifier identifying said data element;
generating message data representing a second financial transaction using a record derived from said repository to position said data element in said message data; and
initiating communication of said data representing said second financial transaction to a remote system.
